(19) United States
(12) Patent Application Publication
(10) Pub. No.: US 2003/0221875 A1
(43) Pub. Date: Dec. 4, 2003

(54) Spine scale

(76) Inventor: Sajid Ali Mirza Khan, Ridgefield Park, NJ (US)

Correspondence Address: SAJID ALI MIRZA KHAN, 2 UNION PLACE, RIDGEFIELD PARK, NJ, 07660, US

(21) Appl. No.: 10/165,343

(22) Filed: Jun. 4, 2002

(51) Int. Cl. G01G 19/00

(52) U.S. Cl. 177/199

(57) ABSTRACT

The spine scale is a body weighing machine that measures the weight of the different parts of the human body in order to determine the health of the spinal chord. It has four weighing scales, enclosed in a single casing, that are electronically connected to measure the weight of four sections of the human body.

### BACKGROUND

Weighing scales or so-called bathroom scales for measuring body weight.

1. Prior Art

We have weighing scales that weigh the whole person, providing the knowledge to lose weight or improve one's fitness. These current scales do not reveal the posture or the position of the spinal chord. My spinal scale reveals the posture of the spinal cord.

2. Objects and Advantages

My spine scale provides the knowledge to lose weight and improve ones fitness as well as it reveals the posture of the person and the condition of his or her spine. It weighs each person in four different ways; the weight of the right, left, back, and front sides of the person's body, thus revealing to the person wheather his or her spine is healthy or not.

### SUMMARY

The spine scale measures the total weight as well as the following four weights; the front quarter, the back quarter, the left quarter, and the right quarter. This gives the person complete knowledge of the health of his or her spine and posture.

### DETAILED DESCRIPTION

The spine scale consists of four similar scales electronically connected and enclosed in a single casing. The person stands on the four square platforms of the four different scales in the following manner: (1)The front side of his or her left foot on the first platform. (2) The back of his or her left foot on the second. (3)The front side of his or her right foot on the third platform. (4) The back side of his or her right foot on the fourth platform. The electronic screen shows the following weights;

(1)The four different weights on the four different platforms.

(2)The total weight on platforms one and two; this is the weight of the left side of the body.

(3)The total weight on platforms three and four; this is the weight of the right side of the body.

(4) The total weight on platforms one and three; this is the weight of the front side of the body.

(5)The total weight on platforms two and four; this is the weight of the back side of the body.

For healthy posture the weight on the right and left must be equal; the front and back weight must also be equal. A small difference will indicate that correcting one's posture might correct the problem, along with exercise. A large difference in weight will suggest professional help is needed.

Operation: the spine scale operates like any other electronic weighing scale. Instead of one platform to stand on the spine scale has four platforms. Only the feet contact has to be equal on all four platforms.

Conclusion: The spine scale reveals whether the person is carrying his body correctly or needs to change his posture, do exercise or seek professional help. This scale can be shaped square, round or oval. The platforms can be square, rectangular, or shaped to accommodate the contours of the feet.

1. (a) A weighing scale comprising of four independent scales, electronically attached to one screen.
(b) Said four scales enclosed in a single casing.
(c) Said scale is capabale of measuring the weight of the four different sections of the human body.
DEPENDENT CLAIM: A chair version of said scale that measures different sections of the human body when the person is siting down.
